(19) United States
(12) Patent Application Publication
(10) Pub. No.: US 2006/0100895 A1
(43) Pub. Date: May 11, 2006

(54) Method for providing digital payload data

(76) Inventor: Arnd Krusche, Stuttgart (DE)

Correspondence Address: FROMMER LAWRENCE & HAUG LLP, 745 FIFTH AVENUE, NEW YORK, NY, 10151, US

(21) Appl. No.: 11/268,426

(22) Filed: Nov. 7, 2005

(30) Foreign Application Priority Data
Nov. 10, 2004 (EP) 04026736.1

(51) Int. Cl. G06Q 99/00

(52) U.S. Cl. 705/1

(57) ABSTRACT

A method for providing digital payload data is provided wherein payload data (PD) belonging to a copyright owner (CO) are provided from an intermediate customer (CO) to a final customer (FC) upon a payload payment (PP) by said final customer (FC) to said copyright owner (CO). According to the present invention an incentive payment (IP) is given to said intermediate customer (IC).

The present invention relates to a method for providing digital payload data. The present invention relates more particularly to a method for online audio/video data distribution and to a business model for online A/V distribution.

In the recent years the provision and the distribution of digital content or digital data in electronic manner, e.g. for instance the distribution of digital data via intranets or via the internet, because more and more important in particular in the field of buying and selling audio material, video material or even software or other digital data. At the same time the burden of creating security measures increases in order to avoid unauthorized and illegal distribution channels. Although the derived security tools and security strategies have been enhanced the failure of said security strategies as well as the amount of illegally copied digital content and the economic damage connected therewith cannot be denied or neglected.

It is an object underlying the present invention to provide a method for providing digital payload data which is capable of decreasing and suppressing the attempts of illegally or unauthorized produced copies of provided digital data and the distribution worldwide.

The object underlying the present invention is solved by a method for providing digital payload data according to independent claim 1. The object is further achieved by a system or apparatus, by a computer program product as well as by a computer readable storage medium according to independent claims 18, 19, and 20, respectively. Preferred embodiments of the inventive method for providing digital payload data are within the scope of the dependent subclaims.

The present invention describes two independent solutions for the discussed object underlying the present invention. According to the first solution as set forth in independent claim 1 the inventive method for providing digital payload data comprises a step (a) of providing a payload payment for digital payload data of a copyright owner by a final customer to said copyright owner by sending respective payload payment data from a final customer's node to a copyright owner's node, a step (b) of providing said digital payload data from an intermediate customer to said final customer by sending said digital payload data or a pre-form thereof from an intermediate customer's node to a final customer's node and a step (c) of providing an incentive payment to said intermediate customer by sending respective incentive payment data to an intermediate customer's node.

It is therefore a basic idea of the inventive method for providing digital payload data according the first solution for the object underlying the present invention to enable an incentive payment to the intermediate customer. By doing so, the intermediate customer is encouraged to avoid an illegal and unauthorized copying and distribution process of the offered digital payload data. This is realized by coupling the process of providing digital payload data by the intermediate customer's node if and only if the payload payment for the respective digital payload data has been realized with respect to the copyright owner. Only under the condition that the payload payment has been fulfilled the process of providing the requested digital payload data is entered. Therefore the process underlying the present invention is strongly coupled to the offering of an incentive payment to the intermediate customer which may be done either by the final customer directly or by the copyright owner directly.

According to the second solution underlying the present invention as set forth in independent claim 3 a method for providing digital payload data is suggested wherein payload data belonging to a copyright owner are provided from an intermediate customer to a final customer, upon a payload payment by said final customer to said copyright owner. Additionally an incentive payment is given to said intermediate customer, for instance as a reward for avoiding illegal and unauthorized distribution of the digital payload data of the copyright owner via the means of said intermediate customer.

Of course both principles, the principle of the first solution of the object underlying the present invention and of the second solution of the object underlying the present invention can be combined.

According to a preferred embodiment of the inventive method for providing digital payload data the method may comprise—in particular in a pre-processing section—a step of requesting said digital payload data of said copyright owner by said final customer from said intermediate customer by sending a respective payload data request from a final customer's node to an intermediate customer's node.

According to an additional or alternative preferred embodiment of the inventive method for providing digital payload data the method may comprise—in particular in a pre-processing section—a step of requesting a payload payment from said final customer by said copyright owner and/or by said intermediate customer by sending from a copyright owner's node and/or from an intermediate customer's node a respective payload payment request with respective payload payment request data to a final customer's node.

According to a further additional or alternative preferred embodiment of the inventive method for providing digital payload data the method may comprise—in particular in a pre-processing section—a step of requesting an incentive payment from said final customer and/or from said copyright owner to said intermediate customer by sending a respective incentive payment request with respective incentive payment request data from an intermediate customer's node or from a copyright owner's node to a final customer's node or to a copyright owner's node.

The step (b) of providing said digital payload data may be performed only upon finalizing step (c) of providing an incentive payment.

Said step (a) of providing said payload payment may be performed directly between said final customer and said copyright owner by directly sending respective payload payment data from a final customer's node to a copyright owner's node or to a related payment service.

Said step (a) of providing said payload payment may alternatively be performed indirectly between said final customer and said copyright owner or a related payment service by indirectly sending respective payload payment data from a final customer's node to a copyright owner's node or said a related payment service, in particular via an intermediate customer's node.

Said step (c) of providing said incentive payment may be performed directly from said final customer and/or from said copyright owner to said intermediate customer or a related payment service by directly sending respective incentive payment data from a final customer's node and/or from a copyright owner's node to an intermediate customer's node or a related payment service.

Said step (c) of providing said incentive payment may alternatively be performed indirectly from said final customer and/or from said copyright owner to said intermediate customer or a related payment service by indirectly sending respective incentive payment data from a final customer's node and/or from a copyright owner's node to an intermediate customer's node or a related payment service, in particular via a copyright owner's node.

Said digital payload data may be or may comprises at least one of audio data, image data, video data and an access code for at least one of audio data, image data, video data.

The inventive method may preferably be adapted for providing digital payload data over a network of devices.

The inventive method may alternatively or additionally be adapted for providing digital payload data over a peer to peer network of peer to peer devices or nodes.

The inventive method may further preferably be based on a standardized access software, in particular based on a Gnutella standard.

The performance of an arbitrary plurality of the steps (a) and (c) may be based on said standardized access software.

The access software may be adapted to allow a process of re-selling of previously sold content. In this case, the final customer FC turns into a new intermediate costumer IC. However, the copyright owner CO remains the same. The transactions are performed accordingly to the new roles.

It is a further aspect of the present invention to provide a system or apparatus for providing digital payload data which are adapted and/or arranged and which comprise means for carrying out the inventive method for providing digital payload data and the steps thereof.

Further, a computer program product is provided comprising computer program means which is adapted and/or arranged in order to perform the inventive method for providing digital payload data and the steps thereof.

Additionally, a computer readable storage medium is provided comprising the inventive computer program product.

These and further aspects of the present invention will be further discussed in the following:

Introduction

Today's online distribution systems are facing severe problems, since copyright infringements are endangering the business of legal audio/video A/V online distribution systems.

Especially peer-to-peer networks are gaining popularity and a lot of content is exchanged on these channels publicly on a large scale.

In order to work against these trends of illegal distribution the hereafter described business model will show a way out of the current dilemma and secure the revenues for the content owner and the whole industry.

The idea is to provide incentives for peer-to-peer content provider to not publicly offering the content for free, by integrating them into the distribution system of the content industry and sharing the revenues with them.

Previously other technical approaches of copy protection, such as watermarks, digital rights management and the like, were followed without integrating peer-to-peer content provider and without providing them incentives to stick to the legal framework.

Problem

State of the art solutions were generally not accepted by the user since those solutions were inconvenient to handle and restrained the user too much. Those approaches did not provide any incentive to the illegal content provider to stop his activities. State of the art solutions rather concentrated on identifying and restricting access to illegal copies, but were not very successful.

Solution

Simple facts change the traditional worlds of retail, entertainment and publishing; the Internet by-passes traditional bricks and mortar retail outlets, the hard drive by-passes CD player and everyone who has a connection to the Internet has access to all the knowledge, literature, art and music that society produces [1].

The Gnutella protocol is one of several protocols which providing a simple reliable distribution system that delivers knowledge, literature, art and music to all. There are no central servers. The network is based on peers that co-operate independently to make a library of digital content. As such, Gnutella embodies a paradigm shift from a world of corporate overlords to networked producers and consumers [1].

This in turn threatens the content owners, since they are not able to generate sustainable cash flows. In order to prevent illegal copying and distribution of audio, video and other content via peer-to-peer (P2P) networks the proposed business model provides incentives not to engage in illegal copyright infringements.

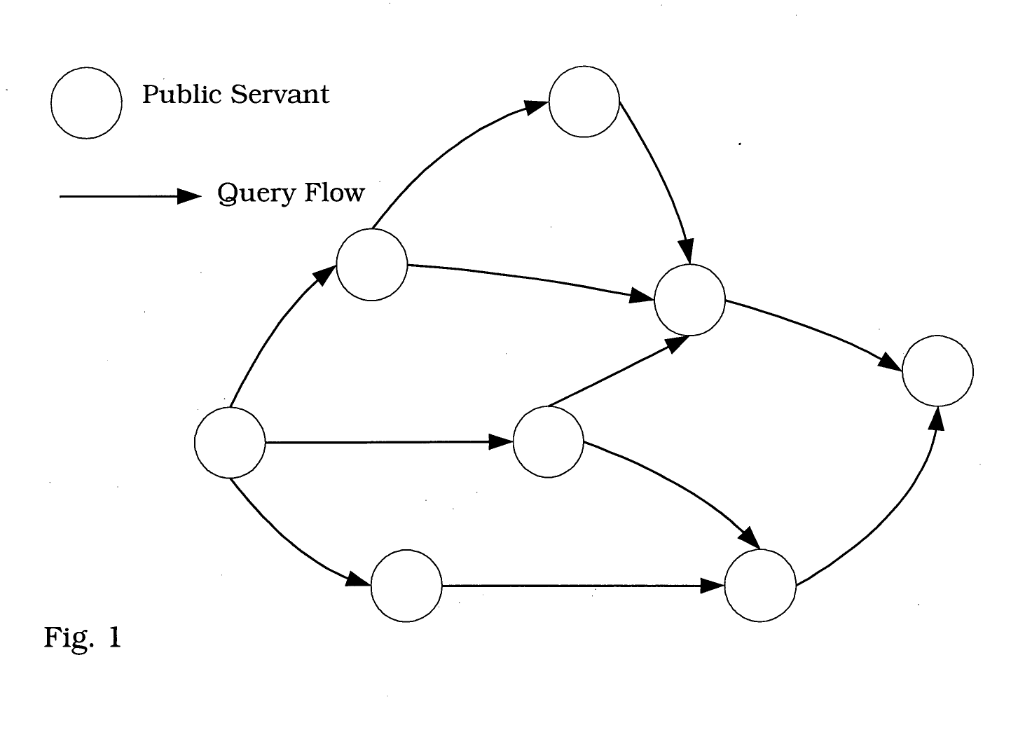

A peer to peer network or P2P network is made of networked servants. A servant is defined as a host acting as both a server and a client in P2P networks. FIG. 1 shows an example of a P2P network and its topology.

P2P network nodes are classified into two groups: ultra peer and leaf. Servants are categorized into leaf and ultra peer. To be qualified as ultra peers, servants should possess sufficient computational power, network bandwidth and long expected uptimes. Detailed principles of electing ultra peers are described in the Gnutella Protocol Specification v0.6 [1].

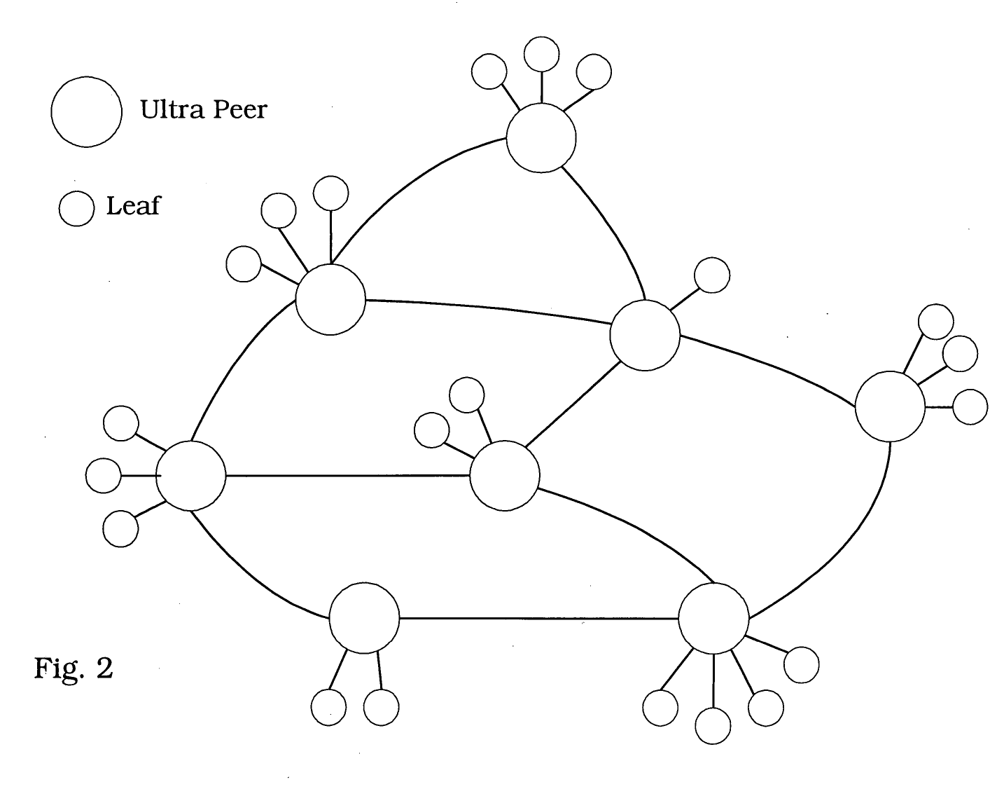

FIG. 2 shows an example of a state-of-the-art Peer-to-peer network with networked ultra peers and leafs.

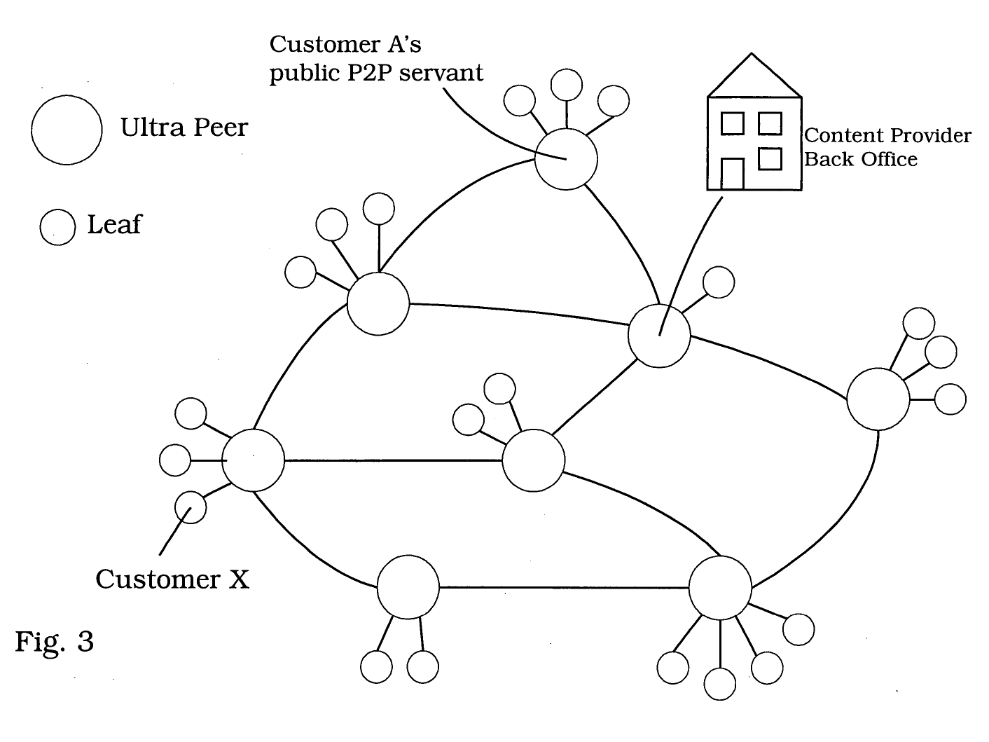

A typical embodiment for the procedure of the proposed invention and the business model is illustrated in FIG. 3 and the respective scenario. FIG. 3 shows a scenario of a peer to peer network integrating the legal on-line distribution system of a content provider or owner or copyright owner.

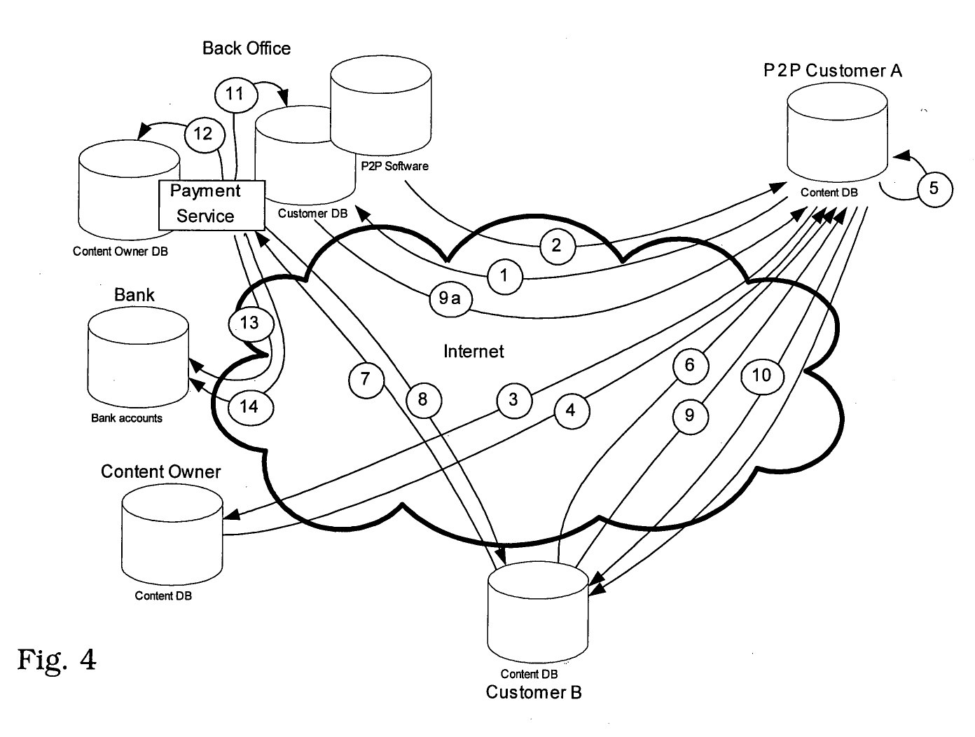

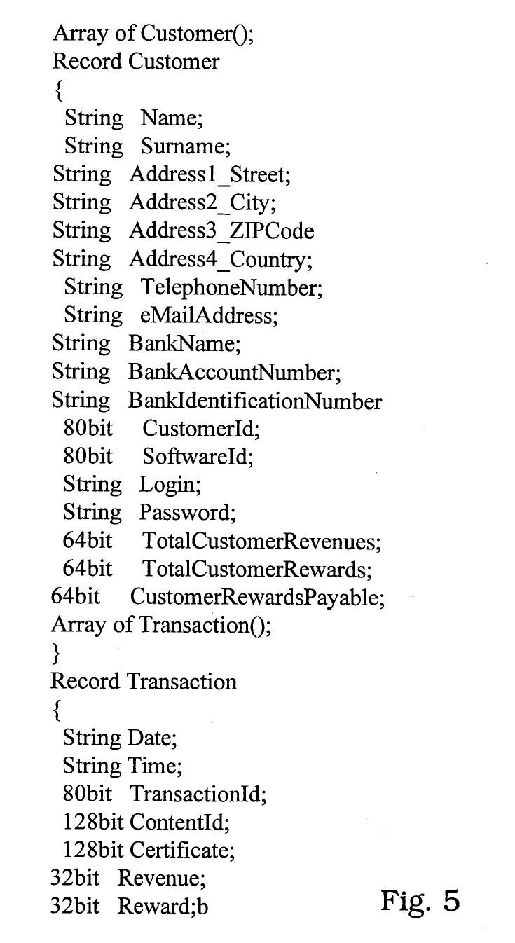

FIG. 4 demonstrates a more detailed explanation of a scenario and of possible steps involved, e.g. steps of registration, software download, payment, content download, in particular by means of a sequence chart.

Due to the incentive payment provided by the content owner/provider or copyright owner the interest in illegal copying and distribution drops significantly. Resulting in low prices for the consumer, higher consumption, no fear of illegal status, earnings for the public servant's operators and secured cash flows for the content owners. All participants will be better off adopting this business model.

FIG. 5 schematically demonstrates a structure of a customer database.

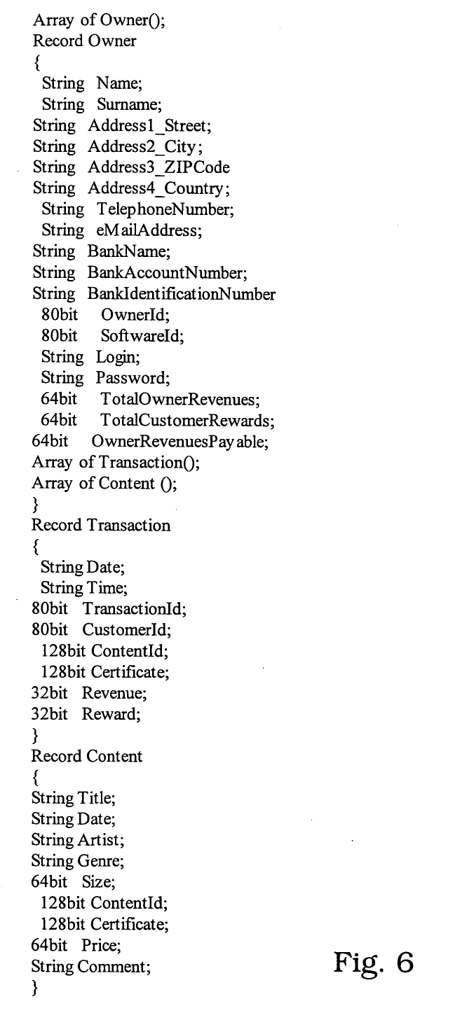

FIG. 6 schematically demonstrates a structure of a owner database.

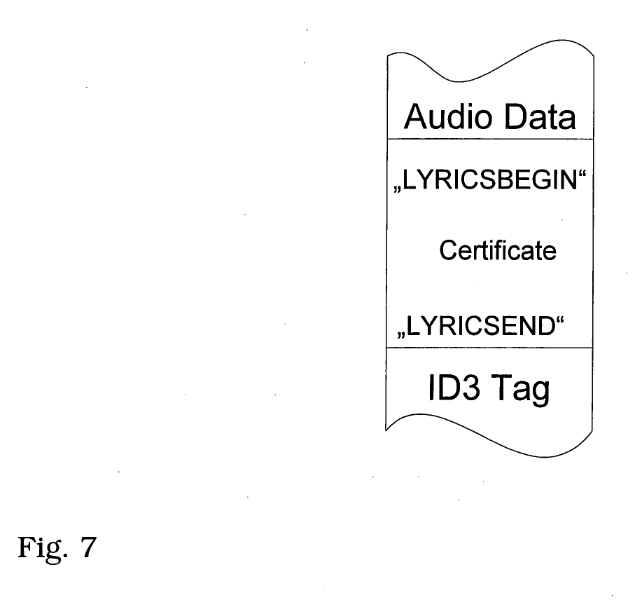

FIG. 7 schematically demonstrates a structure of a lyrics 3 tag.

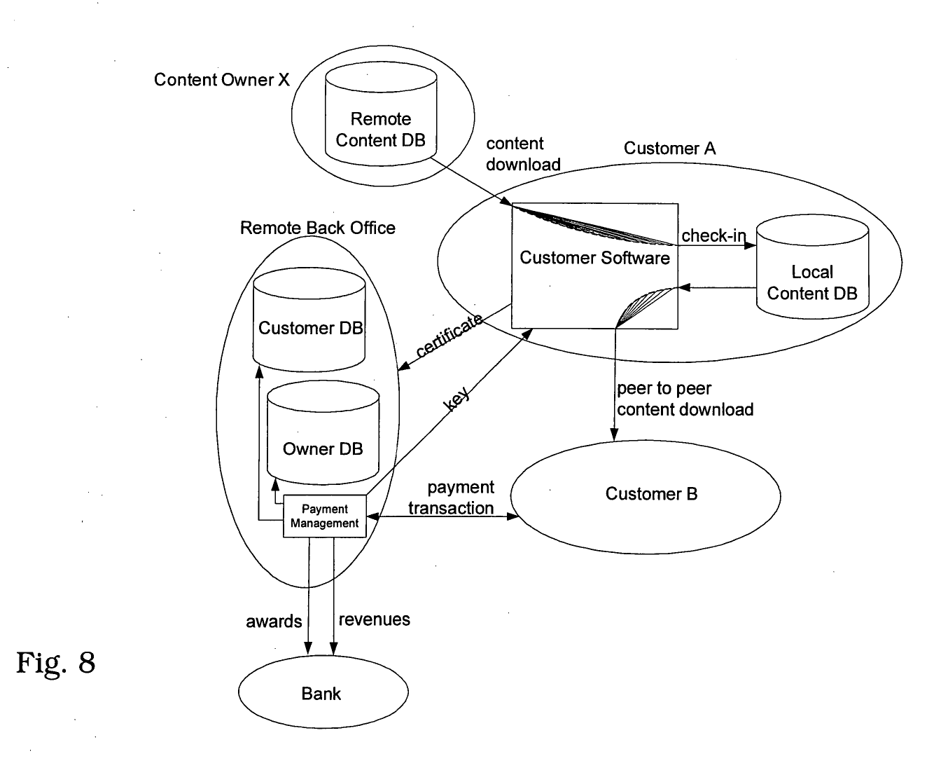

FIG. 8 schematically demonstrates a structure of possible transactions.

Advantages

The main advantageous difference is the integration of the servants (acts as both a server and client in a P2P network) into the legal online distribution system of the content provider and the provision of incentives to eliminate the illegal distribution of content.

In the following these and further aspects of the present invention will be explained in more detail based on preferred embodiments of the present invention and by taking reference to the accompanying figures which schematically demonstrate aspects of the present invention.

FIG. 1 is a schematic diagram elucidating a peer-to-peer-network and its topology which might be used within an embodiment of the inventive method for providing digital payload data and within an inventive apparatus to carry out the inventive method.

FIG. 2 is a schematical diagram which demonstrates a structure of a peer-to-peer-network with networked ultra-peers and leaves which might be used within an embodiment of the inventive method for providing digital payload data and within an embodiment of the inventive apparatus for carrying out the inventive method.

FIG. 3 is a schematical diagram which demonstrates the principles of a typical scenario of a peer-to-peer-network used in an embodiment of the inventive method for providing digital payload data and in an embodiment for the inventive apparatus for carrying out the inventive method.

FIG. 4 is a schematical diagram for elucidating a sequence of an embodiment of the inventive method for providing digital payload data.

FIG. 5 schematically demonstrates a possible structure of a customer data base.

FIG. 6 schematically demonstrates a possible structure of a owner data base.

FIG. 7 schematically demonstrates a possible structure of a lyrics 3 tag.

FIG. 8 is a schematical diagram for elucidating the structure of possible transactions within a preferred embodiment of the inventive method for providing digital payload data.

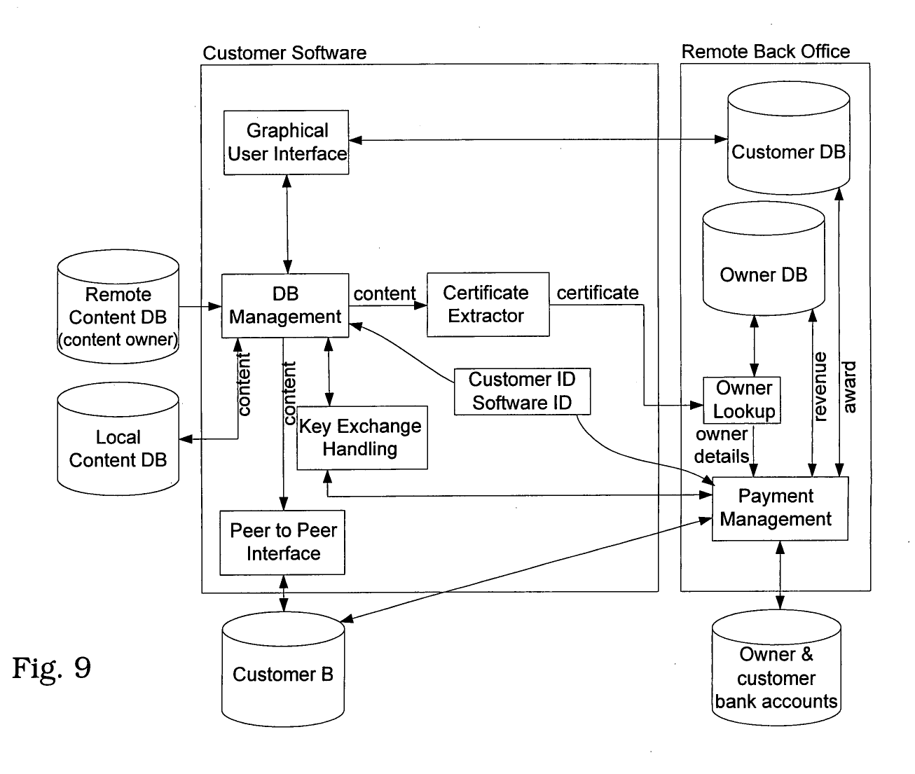

FIG. 9 is a schematical block diagram which demonstrates the structure and the functionality of a customer software and the related remote back of a software used within an embodiment of the inventive method for providing digital payload data.

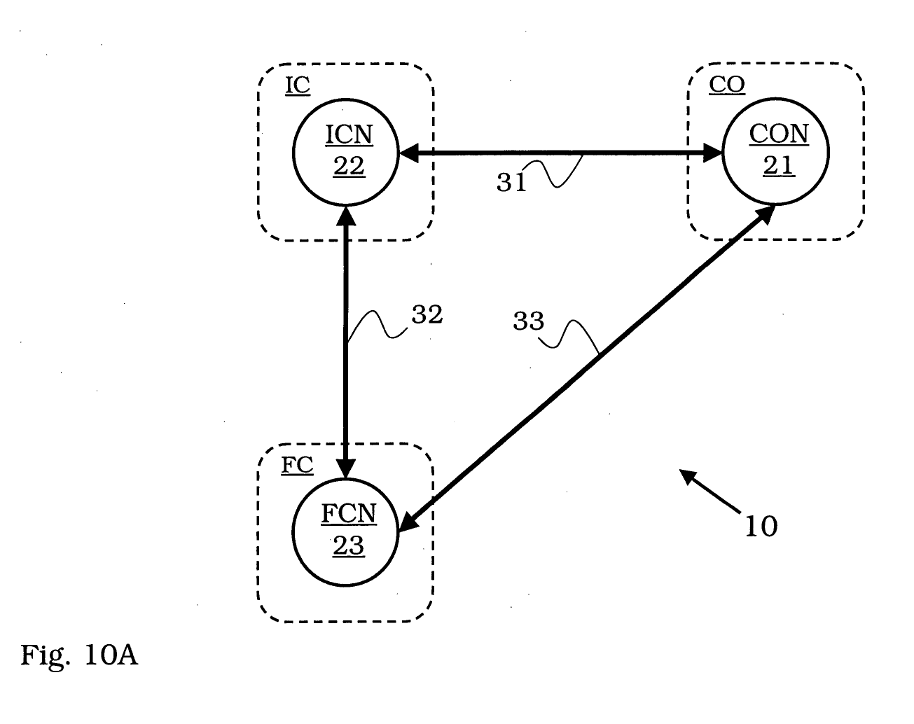

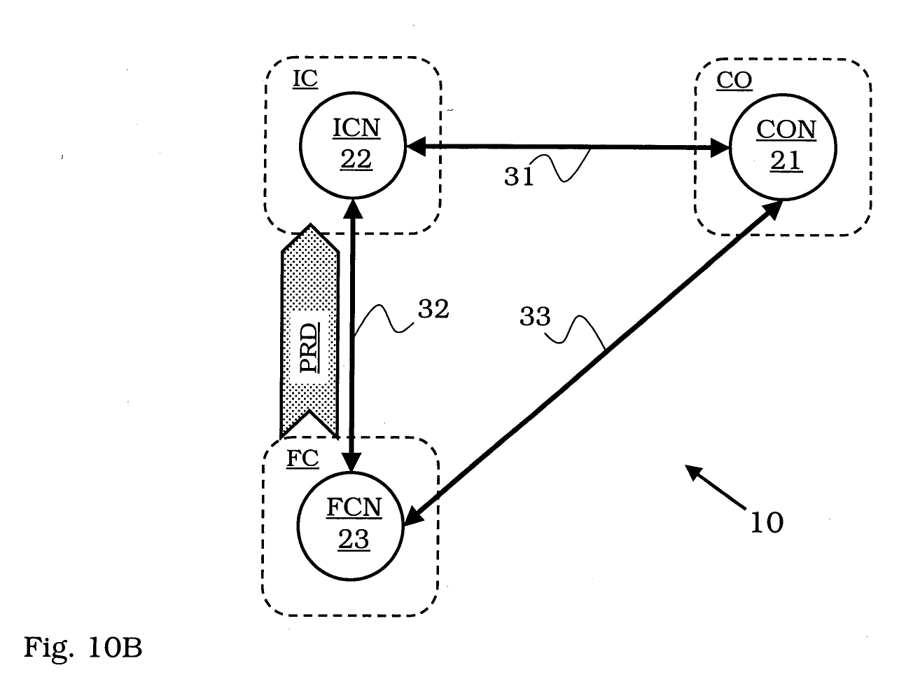

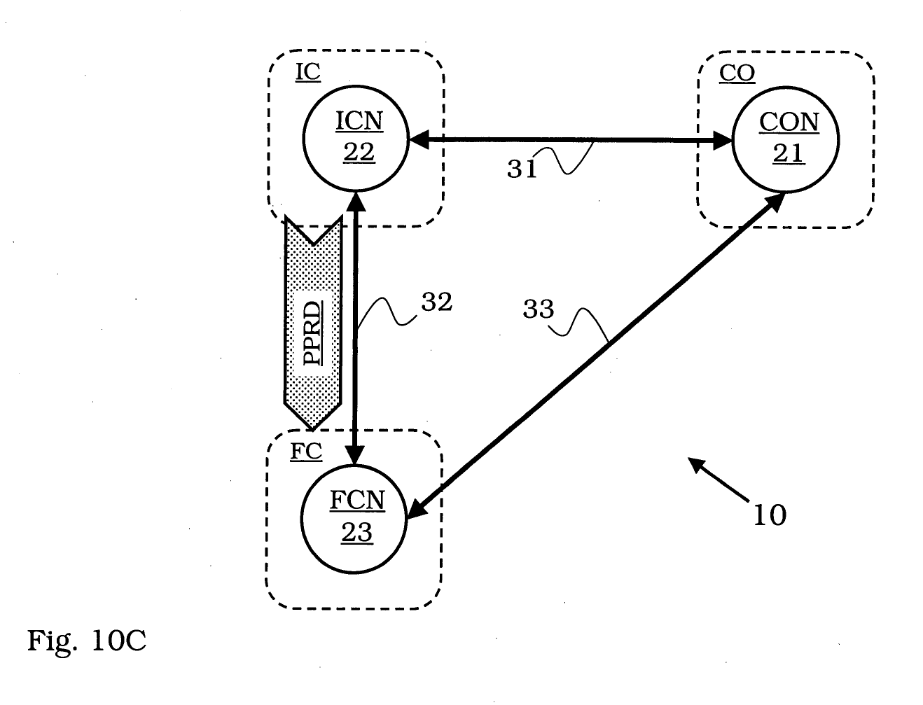

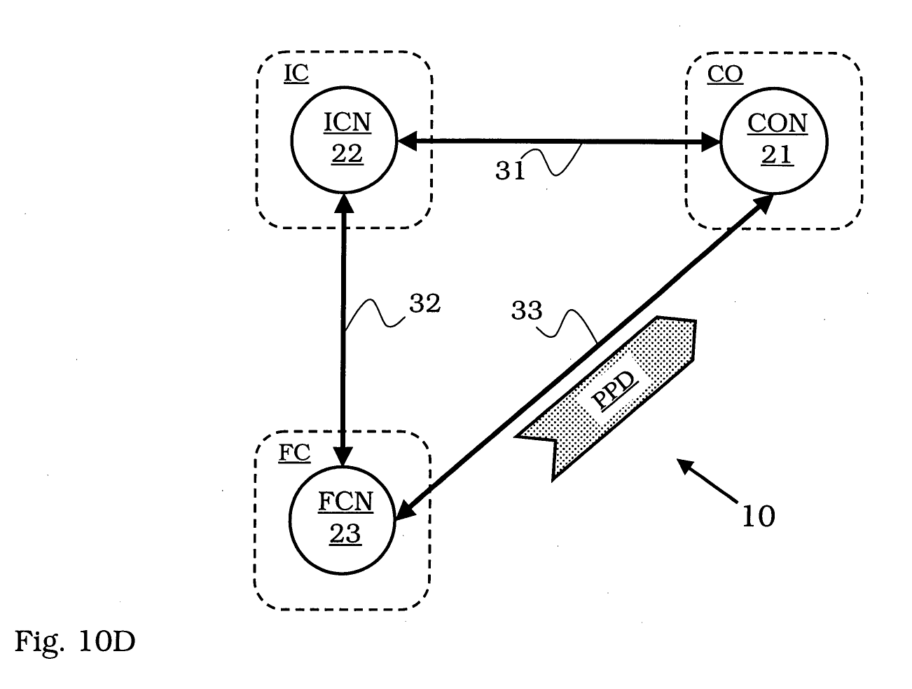

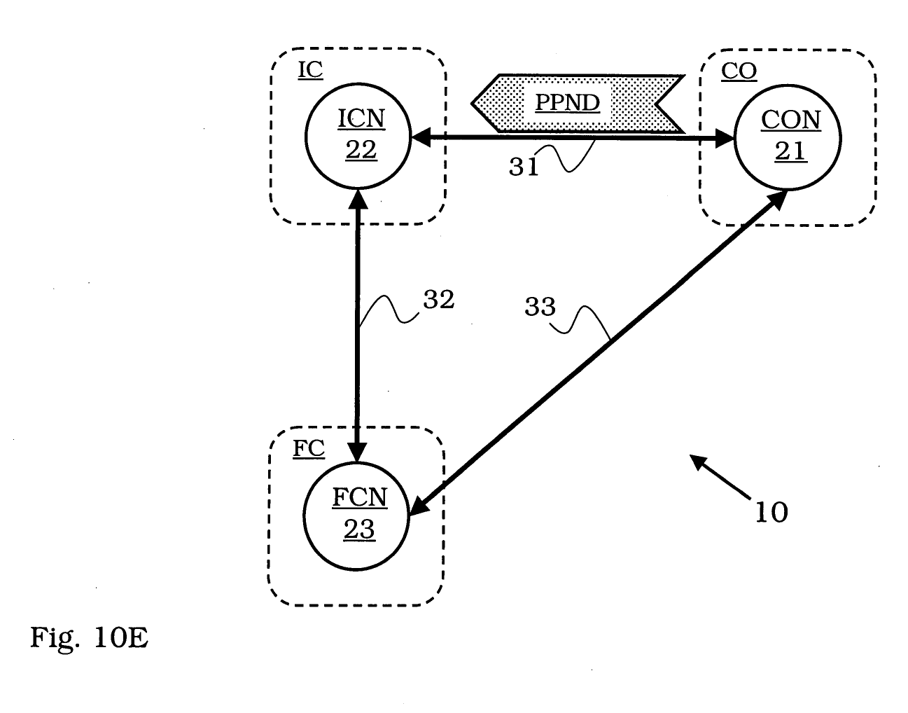

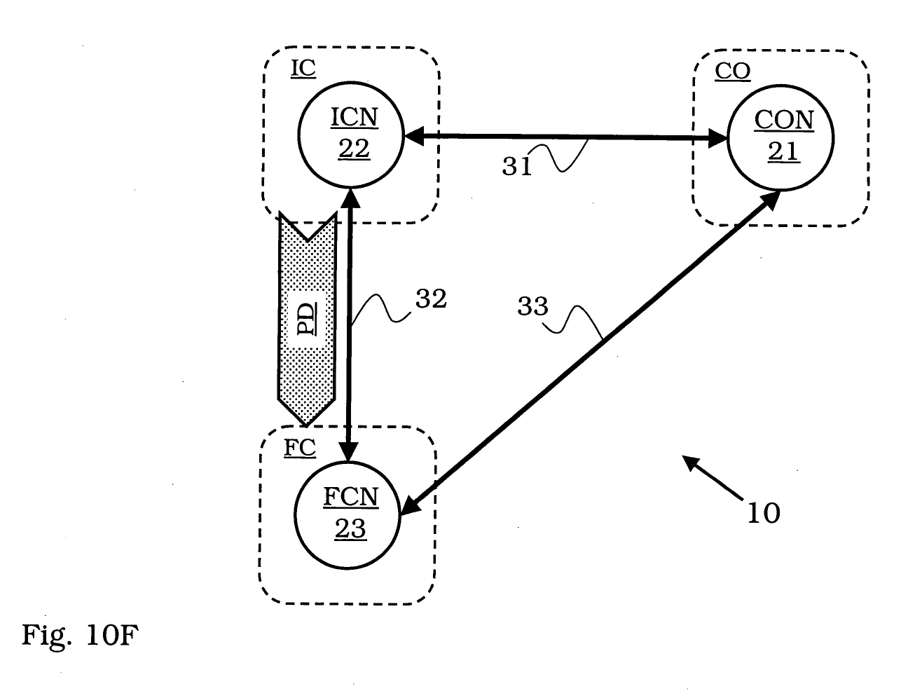

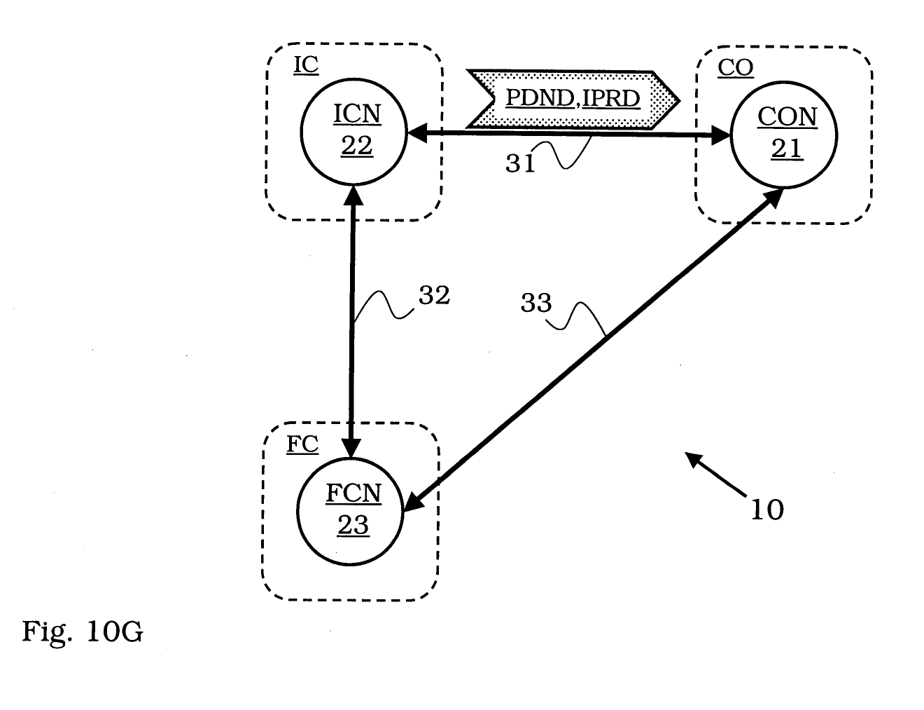

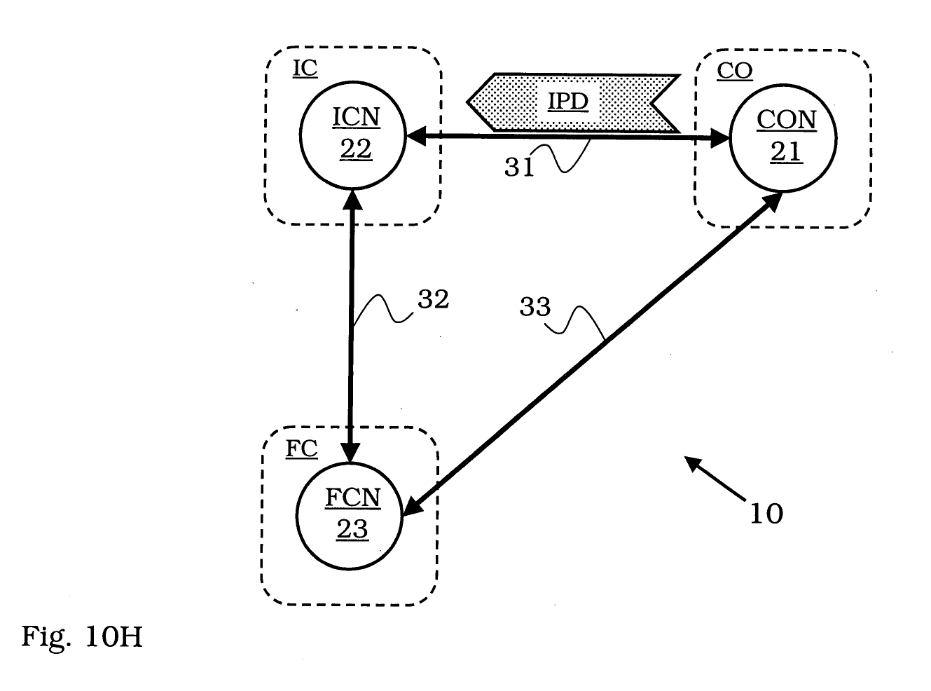

FIG. 10A-H sequentially demonstrate by means of schematical block diagrams principles of a possible sequence of operations of an embodiment of the inventive method for providing digital payload data.

In the following structural and/or functional elements which are comparable, similar or equivalent with respect to each other will be denoted by identical reference symbols. Not in each case of their occurrence a detailed description will be repeated.

First of all some principles of the present invention and the inventive method for providing digital payload data will be elucidated by taking reference to FIGS. 10A to 10H by means of schematical block diagrams.

In FIG. 10A a network 10 is illustrated which can be used within an embodiment of the inventive method for providing digital payload data PD and therefore within an apparatus for carrying out the present invention. The basic network 10 comprises nodes 21, 22 and 23 which are assigned to a copyright owner CO with respect to the underlying payload data PD to an intermediate customer IC, and to a final customer FC, respectively. The first, second and third nodes 21, 22, and 23 are therefore called a copyright owner's node CON, an intermediate customer's node ICN, and a final customer's node 23, respectively. The copyright owner's node CON and the intermediate customer's node ICN are connected with respect to each other by means of a data exchange line 31. The intermediate customer's node ICN and the final customer's node FCN are connected with respect to each other by means of a further data exchange line 32. Finally, the final customer's node FCN and the copyright owner's node are connected with a third data exchange line 33.

The sequence of FIGS. 10B to 10H demonstrates different states of the network 10 which take place within a preferred embodiment of the inventive method for providing digital payload data PD.

In FIG. 10B the final customer FC requests from his final customer's node FCN via data exchange lines 32 a given piece of payload data PD by sending via the transmission of payload request data PRD a payload data request PDR to the intermediate customer's node ICN.

According to the state shown in FIG. 10C the intermediate customer IC checks the request for the payload data PD and replies by sending from its intermediate customer node ICN via the data exchange line 32 a payload data payment request PPR for a payload payment PP to the final customer's node FCN by transmitting respective payload payment request data PPRD.

According to the state shown in FIG. 10D the final customer FC responds by a respective payload payment PP to the copyright owner CO by transmitting respective payload payment data PPD from its final customer's node FCN via data exchange line 33 to the copyright owner's node CON.

The copyright owner CO checks the payload payment data PPD and the respective payload payment PP and responds by sending a payload payment notification to the intermediate customer by transmitting from its copyright owner's node CON via data exchange line 31 respective payload payment notification data PPND to the intermediate customer's node ICN. This is shown in FIG. 10E. According to the state shown in FIG. 10F the intermediate customer IC checks the payload payment notification data PPND and the respective payload payment PP and accordingly either transmits the payload data PD directly from its intermediate customer node ICN via data exchange line 32 to the final customer's node FCN or transmits respective access right data for a payload data download or payload data usage by the final customer FC.

According to FIG. 10G the intermediate customer IC notifies the download of the payload data PD by sending respective payload data notification data PDND from its intermediate customer node ICN via data exchange line 31 to the copyright owner's node CON. At the same time respective incentive payment request data for an incentive payment IP may be transmitted from the intermediate customer's node ICN via data exchange line 31 to the copyright owner's node CON as a request for an incentive payment IP.

According to the state shown in FIG. 10H the copyright owner CO then performs the respective incentive payment IP by transmitting incentive payment data from its copyright owner's node CON via data exchange line 31 to the intermediate customer's node ICN.

FIG. 1 shows an example of a P2P network 10 and its topology which might be involved in an embodiment of the inventive method for providing digital payload data and which might be a part of an embodiment of the inventive system.

A peer to peer network 10 or P2P network 10 according to FIG. 1 is made of networked servants. A servant is defined as a host acting as both a server and a client in P2P networks.

According to FIG. 2 P2P network nodes of a respective P2P network 10 are classified into two groups of ultra peers and leafs. Servants are categorized into leafs and ultra peers. To be qualified as ultra peers, servants should possess sufficient computational power, network bandwidth and long expected uptimes. Detailed principles of electing ultra peers are described in the Gnutella Protocol Specification [1]. FIG. 2 shows an example of a peer to peer network with networked ultra peers and leafs.

FIG. 3 shows a scenario of a peer to peer network integrating the legal on-line distribution system of a content provider. A typical embodiment of the inventive method for providing digital payload data of the proposed invention and the business model related thereto may comprise the following processes:
1. A standardized access software based on P2P protocols like Gnutella is provided free of charge, e.g. via the internet.
2. Customer A, i.e. an intermediate costumer, buys a digital content as digital payload data, e.g. via the internet or in a retail store, which are related to the copyright owner. The copyright owner may also be referred as a content owner with respect to the digital payload data.
3. Customer A, i.e. the intermediate costumer, offers content, i.e. digital payload data, on P2P network with the help of the provided software.
4. Each customer X, i.e. a final costumer, intending to download the content at customer A's public servant, i.e. the intermediate costumer's node, is first charged by the content provider, i.e. the content or copyright owner, with the help of the provided software. The charge is referred to as a payload payment. The price may be relatively low due to the very low distribution costs.
5. Customer X, i.e. the final costumer, gains in this case access rights and downloads content as digital payload data from customer A's servant or node, i.e. from the intermediate costumer's public servant or node, and may be able to render the content. Further restrictions may be given, e.g. number of copies, number of times the content can be rendered, etc., and may or may not be implemented according to different pricing schemes.
6. Customer A, i.e. the intermediate costumer, is rewarded by a certain share of the selling price as an incentive payment.

FIG. 4 demonstrates a more detailed a scenario and possible steps involved, e.g. steps of registration, software download, payment, content download, in particular by means of a sequence chart.
1) P2P customer A as an intermediate costumer registers at a web page provided by the content owner or an independent back office
   Customer database comprises the following record according to FIG. 5: Name, surname, address, telephone number, e-mail address, bank account, customer Id, software Id, login, password, total customer revenues, total customer rewards, customer rewards payable, record of transaction (date, time, transaction Id, content Id, certificate, revenue, reward)
   An unique 80 bit customer Id is assigned
2) P2P customer A, i.e. the intermediate costumer, downloads P2P Software and installs it on his server
   With each download a new 80 bit software Id is assigned and the old software Id becomes invalid
   This software Id together with a 80 bit customer Id is encrypted into the software
3) P2P customer A, i.e. the intermediate costumer, purchases content as digital payload data at content owner's, content provider's or copyright owner's web page or node.
   The money is either debited from a pre-paid user account or paid by other independent internet micro-payment systems via a secure channel.
4) P2P customer A, i.e. the intermediate costumer, downloads content as digital payload data from content owner's, content provider's or copyright owner's web page or node.
   The content is returned with a certificate.
   This certificate is calculated out of the content or digital payload data metrics and hence only usable for this particular content or digital payload data.
   The certificate is used to identify the content owner, content provider or copyright owner.
   If the certificate is invalid and the content owner, content provider or copyright owner can not be identified, the software assumes the content is free (distribution is permitted but nothing is charged and rewarded)
   The certificate can be incorporated as watermark or as Lyrics3Tag between the audio data and the ID3tag within a MP3 file according to FIG. 7
5) Downloaded content as digital payload data is checked into customer A's i.e. intermediate costumer's P2P content server or node.
   The content is visible to the P2P community.
6) Customer B, i.e. a final costumer, decides to purchase content as digital payload data at Customer A, i.e. at said intermediate costumer.
7) Customer B, i.e. the final costumer, pays his purchase via a secure channel by using internet micro-payment services offered by the content owner, content provider or copyright owner or independent micro-payment service providers as a payload payment.
8) A key is issued to customer B, i.e. the final costumer, on a secure channel either from the content owner, content provider or copyright owner or an independent payment system provider.
9) Customer B, i.e. the final costumer, submits key to P2P customer A's, i.e. the intermediate costumer's server on a secure channel
   Customer A's, i.e. the intermediate costumer's software releases the content for download to customer B as digital payload data.
Alternative 9a: Step 8) and 9) could be combined by submitting the key directly from the owner or the payment system provider to the P2P customer A on a secure channel
10) Customer B, i.e. the final costumer downloads content as digital payload data from P2P customer A's, i.e. the intermediate costumer's server.
11) A part of the purchasing price is rewarded to P2P customer A's DB as an incentive payment.
   A possible structure of the customer database is illustrated in FIG. 5.
12) The revenue minus reward is added to content owner's DB
   A possible structure of the content owner database is illustrated in FIG. 6.
13) P2P customer's bank accounts are balanced e.g. once a month.
14) Content owner's bank accounts are balanced e.g. once a week.

Due to the incentive provided by the content owner/provider, the interest in illegal copying and distribution should drop significantly. Resulting in low prices for the consumer, higher consumption, no fear of illegal status, earnings for the public servant's operators and secured cash flows for the content owners. All participants will be better off adopting this business model.

FIG. 5 schematically demonstrates a structure of a customer database.

FIG. 6 schematically demonstrates a structure of a owner database.

FIG. 7 schematically demonstrates a structure of a lyrics 3 tag.

FIG. 8 schematically demonstrates a structure of possible transactions. FIG. 8 illustrates transactions between the various internet nodes, whereas FIG. 9 shows the block diagram of customer software and the remote back office software.

The graphical user interface provides all relevant information (content of the local DB, content of remote P2P or content owner database, status of his customer DB) to the customer.

The DB management block manages all interactions with the local and remote content databases. It also provides the content which is requested by another customer to the certificate extractor, which extracts the certificate out of the content. The certificate can either encrypted as watermark or in the Lyrics3 Tag according to FIG. 7. The certificate is used to determine the owner of the content. Therefore the certificate is forwarded to the owner lookup service running on the remote back office server. This look up service has access to the owner databases where all the content owner information is recorded in a structure according to FIG. 6.

After the owner is determined the buyer is requested to proceed with the payment transaction. The payment service is either provided by the content owner, by the remote back office or third party payment service providers. After the payment transaction is successfully completed a key is issued to the customer software. For security reasons the customer ID and the software ID of the seller are necessary to complete the payment and key exchange transactions. Both IDs are cross checked with the customer DB. After the sellers software received the key, the content is released for download by customer B.

The revenue minus the award is added the owner DB and the award is added to the customers DB. Both accounts are settled up, e.g. once a week or once a month.

### CITED REFERENCES

[1] Gnutella, Gnutella, http://rfc-gnutella.sourceforge.net/index.html, accessed on Jun. 7, 2004.

Reference Symbols

| | |
|---|---|
| 10 | network, peer-to-peer-network |
| 21 | node |
| 22 | node |
| 23 | node |
| 31 | data exchange line, data exchange connection |
| 32 | data exchange line, data exchange connection |
| 33 | data exchange line, data exchange connection |
| CO | copyright owner, content owner, content provider |
| CON | copyright owner's node |
| FC | final customer |
| FCN | final customer's node |
| IC | intermediate customer |
| ICN | intermediate customer's node |
| IP | incentive payment |
| IPD | incentive payment data |
| IPRD | incentive payment request data |
| PD | payload data |
| PDND | payload data notification data |
| PP | Payload payment |
| PPD | payload payment data |
| PPND | payload payment notification data |
| PPRD | payload payment request data |
| PRD | payload request data |

1. Method for providing digital payload data,
comprising steps of:
(a) providing a payload payment (PP) for digital payload data (PD) of a copyright owner (CO) by a final customer (FC) to said copyright owner (CO) by sending payload payment data (PPD) from a final customer's node (FCN) to a copyright owner's node (CON),
(b) providing said digital payload data (PD) from an intermediate customer (IC) to said final customer (FC) by sending said digital payload data (PD) or a pre-form thereof from an intermediate customer's node (ICN) to a final customer's node (FCN), and
(c) providing an incentive payment (IP) to said intermediate customer by sending respective incentive payment data (IPD) to an intermediate customer's node (ICN).

2. Method according to claim 1,
wherein said payload data (PD) belonging to said copyright owner (CO) are provided from said intermediate customer (IC) to said final customer (FC) upon said payload payment (PP) by said final customer (FC) to said copyright owner (CO) and
wherein said incentive payment (IP) is given to said intermediate customer (IC).

3. Method for providing digital payload data,
wherein payload data (PD) belonging to a copyright owner (CO) are provided from an intermediate customer (IC) to a final customer (FC) upon a payload payment (PP) by said final customer (FC) to said copyright owner (CO) and
wherein an incentive payment (IP) is given to said intermediate customer (IC).

4. Method according to claim 3,
comprising steps of:
(a) providing said payload payment (PP) for digital payload data (PD) of said copyright owner (CO) by said final customer (FC) to said copyright owner (CO) by sending payload payment data (PPD) from said final customer's node (FCN) to said copyright owner's node (CON),
(b) providing said digital payload data (PD) from said intermediate customer (IC) to said final customer (FC) by sending said digital payload data (PD) or said pre-form thereof from said intermediate customer's node (ICN) to said final customer's node (FCN), and
(c) providing said incentive payment (IP) to said intermediate customer by sending respective incentive payment data (IPD) to said intermediate customer's node (ICN).

5. Method according to claim 1, comprising—in particular in a pre-processing section—a step (p1) of requesting said digital payload data (PD) of said copyright owner (CO) by said final customer (FC) from said intermediate customer (IC) by sending a respective payload data request (PDR) from a final customer's node (FCN) to an intermediate customer's node (ICN).

6. Method according to claim 1, comprising—in particular in a pre-processing section—a step (p1) of requesting a payload payment (PP) from said final customer (FC) by said copyright owner (CO) and/or by said intermediate customer (IC) by sending from a copyright owner's node (CON) and/or from an intermediate customer's node (ICN) a respective payload payment request (PPR) with respective payload payment request data (PPRD) to a final customer's node (FCN).

7. Method according to claim 1, comprising—in particular in a pre-processing section—a step (p3) of requesting an incentive payment (IC) from said final customer (FC) and/or from said copyright owner (CO) to said intermediate customer (IC) by sending a respective incentive payment request (IPR) with respective incentive payment request data (IPRD) from an intermediate customer's node (ICN) or from a copyright owner's node (CON) to a final customer's node (FCN) or to a copyright owner's node (CON).

8. Method according to claim 1, wherein step (b) of providing said digital payload data (PD) is performed only upon finalizing step (c) of providing an incentive payment (IP).

9. Method according to claim 1, wherein said step (a) of providing said payload payment (PP) is performed directly between said final customer (FC) and said copyright owner (CO) by directly sending respective payload payment data (PPD) from a final customer's node (FCN) to a copyright owner's node (CON) or to a related payment service.

10. Method according to claim 1,
wherein said step (a) of providing said payload payment (PP) is performed indirectly between said final customer (FC) and said copyright owner (CO) or a related payment service by indirectly sending respective payload payment data (PPD) from a final customer's node (FCN) to a copyright owner's node (CON) or said a related payment service, in particular via an intermediate customer's node (ICN).

11. Method according to claim 1,
wherein said step (c) of providing said incentive payment (IP) is performed directly from said final customer (FC) and/or from said copyright owner (CO) to said intermediate customer (IC) or a related payment service by directly sending respective incentive payment data (IPD) from a final customer's node (FCN) and/or from a copyright owner's node (CON) to an intermediate customer's node (ICN) or a related payment service.

12. Method according to claim 1,
wherein said step (c) of providing said incentive payment (IP) is performed indirectly from said final customer (FC) and/or from said copyright owner (CO) to said intermediate customer (IC) or a related payment service by indirectly sending respective incentive payment data (IPD) from a final customer's node (FCN) and/or from a copyright owner's node (CON) to an intermediate customer's node (ICN) or a related payment service, in particular via a copyright owner's node (CON).

13. Method according to claim 1,
wherein said digital payload data (PD) is or comprises at least one of audio data, image data, video data, game data, software code data and an access code for at least one of audio data, image data, video data, game data, software code data.

14. Method according to claim 1, which is adapted for providing digital payload data (PD) over a network of devices (10).

15. Method according to claim 1, which is adapted for providing digital payload data (PD) over a peer to peer network (10) of peer to peer devices or nodes (21, 22, 23).

16. Method according to claim 1, which is based on a standardized access software, in particular based on a Gnutella standard.

17. Method according to claim 1, wherein the performance of an arbitrary plurality of the steps (a) and (c) is based on said standardized access software.

18. Method according to claim 1, wherein the access software is adapted to allow a process of re-selling of previously sold content.

19. System or apparatus for providing digital payload data, which is adapted and/or arranged and which comprises means for carrying out a method for providing digital payload data according to claim 1 and the steps thereof.

20. Computer program product comprising computer program means, which is adapted and/or arranged in order to perform a method for providing digital payload data according to claim 1 and the steps thereof.

21. Computer-readable storage medium comprising a computer program product according to claim 20.
